(19) United States
(12) Patent Application Publication
(10) Pub. No.: US 2016/0231437 A1
(43) Pub. Date: Aug. 11, 2016

(54) Detector Apparatus For A Computed Tomography System

(71) Applicant: Siemens Aktiengesellschaft, Muenchen (DE)

(72) Inventors: Shameem Kabir Chaudhury, Erlangen (DE); Karsten Handt, Burgthann (DE); Thomas Hilderscheid, Altdorf (DE); Thomas Komma, Ottobrunn (DE)

(73) Assignee: Siemens Aktiengesellschaft, Muenchen (DE)

(21) Appl. No.: 15/015,666

(22) Filed: Feb. 4, 2016

(30) Foreign Application Priority Data
Feb. 10, 2015 (DE) 10 2015 202 320.6

(51) Int. Cl. G01T 1/175; G01T 1/24

(52) U.S. Cl. CPC G01T 1/175; G01T 1/24

(57) ABSTRACT

A detector apparatus includes a number of detectors for assigned radiation sources of a computed tomography system, wherein each detector may require a constant input voltage in a range between 900 V and 1200 V. During operation of the detector apparatus, an auxiliary voltage is fed to a high voltage source to supply power to the input terminals on the number of detectors. The high voltage source includes a central first DC-DC converter, to which the auxiliary voltage is fed, and a number of second DC-DC converters arranged downstream of the first DC-DC converter. The first and the second DC-DC converter are based on different power supply topologies, wherein each second DC-DC converter generates the constant input voltage in the predetermined range from a central output voltage provided by the first DC-DC converter and supplies the constant input voltage to a corresponding detector.

### CROSS-REFERENCE TO RELATED APPLICATIONS

This application claims priority to DE Application No. 10 2014 225 810.3 filed Dec. 15, 2014, the contents of which are hereby incorporated by reference in their entirety.

### TECHNICAL FIELD

The invention relates to a detector apparatus having a number of detectors for assigned radiation sources of a computed tomography system and having a high voltage source for supplying power to the number of detectors.

### BACKGROUND

The detectors for assigned radiation sources of a computed tomography system require a high voltage in the range of several 100 V in order to count the light quanta striking the respective detector surface. To this end each of the detectors is connected to the high voltage source by means of a high voltage cable. A computed tomography system generally comprises a plurality of detectors, which therefore renders the wiring effort in the computed tomography system very high.

Contrary to detectors used until now, novel detectors based on cadmium telluride sensors change their resistance as a function of the light quanta that strike instead of counting them. This is advantageous in that there is no need to perform an intermediate step in order to convert light into an electrical signal, as a result of which greater accuracy can be achieved during the image recording or image processing. Measuring a change in resistance results in the problem that the supply voltage provided to the individual detectors has to be adjustable in an almost fault-free and very precise manner. This requirement is not met by the high voltage sources used for conventional detectors. Moreover, the sensors based on cadmium telluride have to be supplied with a comparably significantly higher voltage in a range between 900 V and 1200 V than conventional detectors.

### SUMMARY

One embodiment provides a detector apparatus comprising a number of detectors for assigned radiation sources of a computed tomography system, wherein for its operation each of the detectors requires a constant input voltage of a predetermined level, in particular in a range between 900 V and 1200 V; and a high voltage source for supplying voltage to the number of detectors, to which, during operation of the detector apparatus, an auxiliary voltage is supplied to its input terminals, wherein the high voltage source comprises a central first DC-DC converter, to which the auxiliary voltage is supplied, and a number of second DC-DC converters arranged downstream of the first DC-DC converter, wherein the first and the second DC-DC converter are based on different power supply topologies, wherein in each case a second DC-DC converter supplies a detector with the input voltage and a respective second DC-DC converter generates the input voltage of a predetermined level from a central output voltage provided by the first DC-DC converter.

In a further embodiment, the first DC-DC converter is embodied as a resonance converter, which increases the auxiliary voltage to an output voltage, which is higher than the input voltage of a predetermined level of the number of detectors.

In a further embodiment, the first DC-DC converter is embodied to reduce an amplitude of an AC voltage component of the auxiliary voltage to a comparably lower level.

In a further embodiment, the number of second DC-DC converters are linear regulators, which reduce the central output voltage provided by the first DC-DC converter to the input voltage required by the number of detectors.

In a further embodiment, the number of second DC-DC converters are embodied to correct the amplitude of the AC voltage component to the central output voltage of the first DC-DC converter.

In a further embodiment, the auxiliary voltage is obtained by an apparatus for power factor correction, which is embodied to generate the in-phase auxiliary voltage from a single-phase AC mains supply voltage.

In a further embodiment, the in-phase auxiliary voltage is greater than a peak value of the AC mains supply voltage.

In a further embodiment, the apparatus for power factor correction is connected to the high voltage source by way of a cable.

In a further embodiment, the number of second DC-DC converters and the number of detectors are arranged on a shared circuit board.

In a further embodiment, the first DC-DC converter is arranged on the shared circuit board.

In a further embodiment, the first DC-DC converter and the number of second DC-DC converters can be connected to one another by way of a conductor track structure attached to the shared circuit board.

In a further embodiment, the number of detectors comprise cadmium telluride sensors.

### BRIEF DESCRIPTION OF THE DRAWINGS

Example embodiments of the invention are explained in more detail below with reference to the drawings, in which:

FIG. 1 shows a schematic representation of an inventive detector apparatus for a computed tomography system including only one single detector, according to one embodiment; and

FIG. 2 shows a schematic representation of an inventive detector apparatus for a computed tomography system having multiple detectors, according to one embodiment.

### DETAILED DESCRIPTION

Embodiments of the present invention specify a detector apparatus in which a low-interference, precisely adjustable and load-independent voltage can be supplied to a number of detectors of the detector apparatus.

A detector apparatus comprises a number of detectors for assigned radiation sources of a computed tomography system and a high voltage source for supplying power to the number of detectors. The number of detectors is embodied such that for its operation each of the detectors requires a constant input voltage of a predetermined level, in particular in a range between 900 V and 1200 V. During operation of the detector apparatus, an auxiliary voltage is fed to the input terminals of the high voltage source, wherein the high voltage source comprises a central first DC-DC converter, to which the auxiliary voltage is fed, and a number of second DC-DC converters arranged downstream of the first DC-DC converter. The first and the second DC-DC converters are based on different power supply topologies, i.e. different converter types. A second DC-DC converter supplies a detector with the input voltage in each case. Each second DC-DC converter generates the input voltage of a predetermined level from a central output voltage provided by the first DC-DC converter.

The high voltage source thus comprises two different DC-DC converters which are connected in series, as a result of which a low-interference voltage on the one hand and a precisely adjustable voltage on the other hand can be provided in order to supply the number of detectors. In particular, it is possible to provide a detector apparatus, in which very high output voltages, in particular in the range of 900 V to 1200 V, can be provided extremely precisely for a number of detectors.

As a result of the high voltage source comprising a central first DC-DC converter and a number of downstream second DC-DC converters which corresponds to the number of detectors, only a single high voltage connection, for instance in the form of a cable, is required in order to supply the central first DC-DC converter. The connection between the central first DC-DC converter and the number of downstream second DC-DC converters can then take place more easily, e.g. using corresponding conductor track structures. As a result, the high voltage source can be provided with a significantly lower volume by comparison with conventional high voltage sources.

According to one embodiment, the first DC-DC converter is embodied as a resonance converter, which raises the auxiliary voltage to an output voltage, which is higher than the input voltage of a predetermined level of the number of detectors. In particular, the first DC-DC converter is embodied to reduce an amplitude of an AC voltage component of the auxiliary voltage to a comparably lower level.

The use of the central first DC-DC converter thus allows the intermediate circuit voltage, onto which an AC voltage component is overlaid, which disadvantageously influences the detectors during the image recording, to be reduced to a lower level. This is effected in particular by the smoothing capacitors provided in resonance converters.

According to a further embodiment, the number of second DC-DC converters are linear regulators, which reduce the central output voltage provided by the first DC-DC converter to the output voltage required by the number of detectors. The number of second DC-DC converters is embodied here in particular to correct the amplitude of the AC voltage component to the central output voltage of the first DC-DC converter. A correction is understood to mean an elimination of a level which cannot be detected metrologically or only with extremely significant effort. As a result, an input voltage can be provided to the number of detectors, which is not only extremely precisely adjustable in terms of its level, but now has practically no AC voltage component. Detectors which are based on the principle of resistance measurement can in particular profit from this. However, the signal quality of detectors, which in the known manner count light quanta striking the detectors, can also be improved.

The auxiliary voltage is expediently obtained by an apparatus for power factor correction, which is embodied to generate an auxiliary voltage from a single-phase AC mains supply voltage. The apparatus for power factor correction is also known as the power factor correction circuit (PFC). Such apparatuses operate in a single-phase AC voltage network (i.e. e.g. the 230 V network), wherein the output voltage of the apparatus for power factor correction is a DC voltage, which is greater than the peak value of the AC voltage. For instance, the value of the output voltage of an apparatus for the power factor correction amounts to 380 VDC and represents the auxiliary or intermediate circuit voltage. On account of the never constant instantaneous power of the single-phase AC voltage (i.e. the input voltage of the apparatus for power factor correction), the auxiliary or intermediate circuit voltage is overlaid with an AC voltage component of 100 Hz (if the frequency of the AC mains supply voltage amounts to 50 Hz, otherwise different values will result) with an amplitude of approx. 10 to 20 VAC. This AC voltage component referred to as ripple voltage negatively influences the sensors during the image recording. The afore-described high voltage source allows the disadvantages to be eliminated.

The in-phase auxiliary voltage is greater than a peak value of the AC voltage.

According to a further embodiment, the apparatus for power factor correction is connected to the high voltage source by way of a cable. More specifically, the apparatus for power factor correction is connected to the central first DC-DC converter of the high voltage source.

In contrast, the number of second DC-DC converters and the number of detectors can be arranged on a shared circuit board. This shared circuit board is referred to as a backplane. Each second DC-DC converter and each detector can be arranged as modules on corresponding separate circuit boards, with the modules then being connected to the shared circuit board.

The first DC-DC converter can optionally also be arranged on the shared circuit board.

According to a further embodiment, the first DC-DC converter and the number of second DC-DC converters can be connected to one another by way of a conductor track structure attached to the shared circuit board. On account of this design, it is not necessary to supply the detectors with the required input voltage by way of a respective high voltage cable, as a result of which the inventive detector apparatus requires a lower overall volume compared with conventional detector apparatuses.

According to one embodiment, the number of detectors comprises cadmium telluride sensors, which, as described in the introduction, require a high-precision input voltage in order to make it possible to measure, due to changes in resistance, the light quanta striking the detectors.

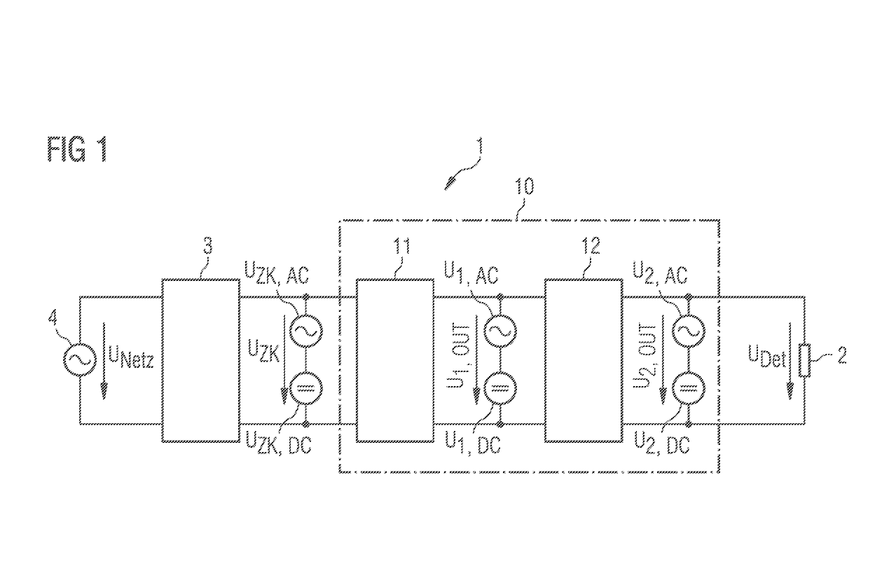

FIG. 1 shows a schematic representation of an inventive detector apparatus 1. For the sake of simplicity, only one individual detector 2 is shown in FIG. 1, which is supplied with a constant input voltage U_{Det} of a predetermined level by a high voltage source 10. The detector is preferably a cadmium telluride sensor, which requires an input voltage in the range between 900 V and 1200 V. In some embodiments, to ensure that a change in resistance in the detector can be registered when the x-ray quanta strike, which are emitted by a radiation source (not shown) assigned to the detector 2, the input voltage U_{Det} available to the detector 2 is virtually free of interference voltage, extremely precisely adjustable and load-independent. This feature is provided by the high voltage source 10 described in more detail below.

The high voltage source 10 comprises a first central DC-DC converter 11 for supplying the detector 2 and a second DC-DC converter 12 arranged downstream of the first DC-DC converter 11. The high voltage source 10 or its first central DC-DC converter 11 is supplied from an apparatus 3 for power factor correction (also known as power factor correction circuit, PFC). The apparatus 3 for power factor correction is connected for its part to an AC voltage source 4.

The AC voltage source 4 provides a single-phase AC voltage U_{Net}, e.g. with a voltage of 220 V at 50 Hz, which is converted into a DC voltage U_{ZK} by the apparatus 3 for power factor correction. The intermediate circuit voltage U_{ZK} has a level which is greater than the peak value of the AC mains supply voltage amounting to 220 V. The value of the intermediate circuit voltage U_{ZK}=380 generally amounts to VDC=U_{ZK,DC}. On account of the never constant instantaneous power of the single-phase AC voltage of the AC voltage source 4, the intermediate circuit voltage U_{ZK} is an AC voltage component U_{ZK,AC} of in this example 100 Hz overlaid with an amplitude of approx. 10 to 20 VAC. The intermediate circuit voltage U_{ZK} is thus composed of the total of U_{ZK,DC} and U_{ZK,AC}. The 100 Hz ripple voltage disadvantageously influences the detector 2 during an image recording.

The first DC-DC converter 11 embodied as a resonance converter, to which the intermediate circuit voltage U_{ZK} overlaid with the 100 Hz ripple is fed, sets the intermediate circuit voltage to a level U_{1,OUT} wherein the voltage level of U_{1,DUT} lies above the required input voltage U_{Det} of the detector 2. As is known, a resonance converter has an internal voltage regulator, which, in conjunction with smoothing capacitors reduces 100 Hz ripple to a very much lower level of approx. 1 to 2 V. This AC voltage component overlaying the DC voltage component U_{1,DC} of U_{1,OUT} is identified with U_{1,AC}. The output voltage U_{1,DUT}, which is thus composed of the DC voltage component U_{1,DC} and the AC voltage component U_{1,AC}, is fed to the second, downstream DC-DC converter 12.

The first DC-DC converter 11 thus raises the DC input voltage U_{ZX} amounting to 380 V to a DC output voltage amounting to between 900 V and 1200 V. The DC output voltage, which is also referred to as a central output voltage U_{1,OUT}, depends on the input voltage U_{Det} of the detector 2 actually required. The first DC-DC converter 11 embodied as a resonance converter has the property of generating extremely low interferences in its surroundings.

The second DC-DC converter 12 is embodied as a linear regulator, and reduces the output voltage U_{1,OUT} of the resonance converter to a level of the input voltage U_{Det} required by the detector 2. Here the linear regulator corrects the 100 Hz ripple voltage, i.e. the AC voltage component U_{1,AC} almost fully. The output voltage U_{2,OUT} supplied by the second DC-DC converter 12 thus only comprises the DC voltage component U_{2,DC}, while the AC voltage component U_{2,AC} can no longer be measured using conventional means. This is therefore shown with a dashed line.

The second, downstream DC-DC converter 12 is thus embodied as a linear regulator. This reduces the output voltage U_{1,OUT} generated by the first DC-DC converter 11 embodied as a resonance converter to the voltage level U_{2,OUT}=U_{Det} required by the detector 2. On account of its non-clocked operation, a linear regulator does not generate any interference whatsoever in its surroundings and on the detector to be supplied.

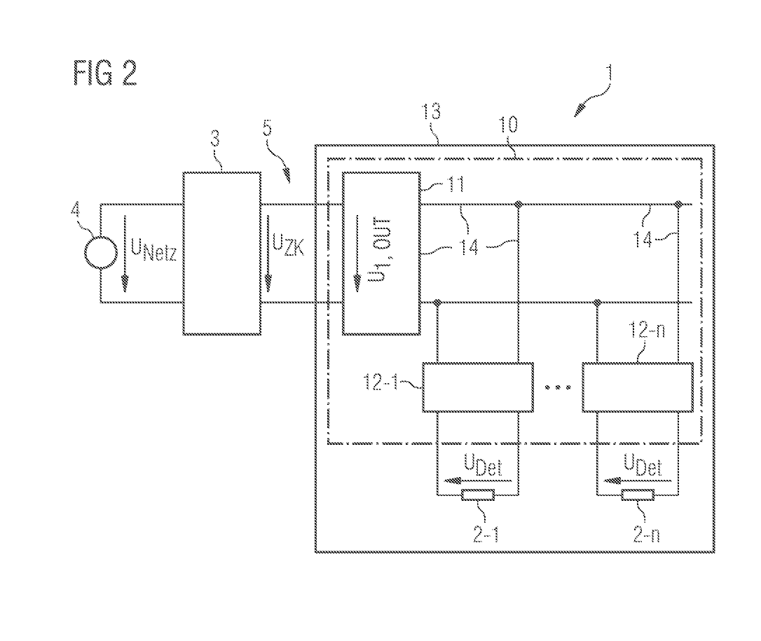

FIG. 2 shows a detector apparatus having a number n of detectors 2-1, . . . , 2-n. A second DC-DC converter 12-1, . . . , 12-n is assigned to each of the detectors 2-1, . . . , 2-n. The second DC-DC converters 12-1, . . . , 12-n are connected in each case to output terminals of the first central DC-DC converter 11. The electrical connection between the first central DC-DC converter 11 and the n second DC-DC converters 12-1, . . . , 12-n is realized by way of a conductor track structure for instance. The conductor track structure 14 can be embodied as a bus structure.

Here the conductor track structure 14, the first DC-DC converter 11, the second DC-DC converters 12-1, . . . , 12-n and the n detectors 2-1, . . . , 2-n can be disposed on a shared circuit board 13, known as a backplane. The detectors 2-1, . . . , 2-n and the second DC-DC converters 12-1, . . . , 12-n can be embodied on respective modular circuit boards, wherein the respective modular circuit boards are electrically and mechanically connected to the shared circuit board 13. The connection between the first DC-DC converter 11 and the apparatus 3 for power factor correction can take place by way of a single high voltage cable 5.

Any PFC circuit known from the prior art can be used as an apparatus 3 for power factor correction. Such an arrangement is known for instance from the technical documentation [1], which is available at www.ti.com/lit/ds/symlink/ucc28180.pdf.

The first DC-DC converter 11 embodied as a resonance converter can be embodied for instance as shown in the technical documentation [2] which is available at www.ti.com/lit/ds/symlink/ucc25600.pdf. In principle other types of resonance converters are also conceivable, provided these are suited to increasing the intermediate circuit voltage U_{ZK} to above the input voltage of a predetermined level of the number of detectors 12-1, . . . , 12-n.

A switching arrangement as shown in the technical documentation [3], which is available at www.fairchildsemi.com/datasheets/LM/LM7824.pdf, can be used as a linear regulator of the DC-DC converter 12-1, . . . , 12-n for instance.

The disclosed detector apparatus enables a number of detectors 2-1, . . . , 2-n to be supplied with a high voltage from a central DC-DC converter 11 and the voltage to be individually adjusted to the required input voltage of a predetermined level of the detectors 2-1, . . . , 2-n by means of the second DC-DC converters 12. Very high output voltages in the range of 1 kV can be distributed extremely precisely to a number of detectors. Since only an individual, central DC-DC converter 11 generates the high voltage in the kV range, only a single high voltage cable is required, which connects the first DC-DC converter 11 with the apparatus 3 for power factor correction. The connection between the second DC-DC converters 12-1, . . . , 12-n and the first DC-DC converter 11 can take place by way of a conductor track structure without the use of cables.

The detector apparatus has a small space requirement and a simple structural design. In particular, the detectors and the second DC-DC converters can be provided in the form of modules, which can be arranged on a shared circuit board, known as the backplane, together with the first DC voltage source.

### REFERENCES

[1] Texas Instruments, UCC28180 Programmable Frequency, Continuous Conduction Mode (CCM), Boost Power Factor Correction (PFC) Controller, December 2014, which is available at www.ti.com/lit/ds/symlink/ucc28180.pdf
[2] Texas Instruments, 8-Pin High-Performance Resonant Mode Controller, July 2011 which is available at www.ti.com/lit/ds/symlink/ucc25600.pdf
[3] Fairchild Semiconductor Corporation, LM78XX/LM78XXA 3-Terminal 1 A Positive Voltage Regulator, September 2014 which is available at www.fairchildsemi.com/datasheets/LM/LM7824.pdf

What is claimed is:

1. A detector apparatus, comprising:
one or more detectors corresponding to assigned radiation sources of a computed tomography system, wherein each detector operates with a constant input voltage in a predetermined range between 900 V and 1200 V;
a high voltage source configured to supply to the one or more of detectors, wherein an auxiliary voltage is supplied to input terminals of the high voltage source during operation of the detector apparatus.
wherein the high voltage source comprises:
a central first DC-DC converter to which the auxiliary voltage is supplied, and
one or more second DC-DC converters arranged downstream of the first DC-DC converter,
wherein the first DC-DC converter and the one or more second DC-DC converters embody different power supply topologies, and
wherein each second DC-DC converter generates the constant input voltage in the predetermined range from a central output voltage provided by the first DC-DC converter, and supplies the constant input voltage to a corresponding detector.

2. The detector apparatus of claim 1, wherein the first DC-DC converter comprises a resonance converter, which increases the auxiliary voltage to an output voltage that is higher than the constant input voltage of the one or more detectors.

3. The detector apparatus of claim 1, wherein the first DC-DC converter is configured to reduce an amplitude of an AC voltage component of the auxiliary voltage to a lower level.

4. The detector apparatus of claim 1, wherein the one or more second DC-DC converters comprise linear regulators configured to reduce the central output voltage provided by the first DC-DC converter to the constant input voltage supplied to the one or more detectors.

5. The detector apparatus of claim 1, wherein the one or more second DC-DC converters are configured to correct an amplitude of an AC voltage component of the auxiliary voltage to the central output voltage of the first DC-DC converter.

6. The detector apparatus of claim 1, comprising a power factor correction apparatus configured to generate the auxiliary voltage as an in-phase voltage from a single-phase AC mains supply voltage.

7. The detector apparatus of claim 6, wherein the in-phase auxiliary voltage is greater than a peak value of the AC mains supply voltage.

8. The detector apparatus of claim 6, wherein the power factor correction apparatus is connected to the high voltage source via a cable.

9. The detector apparatus of claim 1, wherein the one or more second DC-DC converters and the one or more detectors are arranged on a shared circuit board.

10. The detector apparatus of claim 9, wherein the first DC-DC converter is arranged on the shared circuit board.

11. The detector apparatus of claim 9, wherein the first DC-DC converter and the one or more second DC-DC converters are connected to one another by a conductor track structure attached to the shared circuit board.

12. The detector apparatus of claim 1, wherein the one or more detectors comprise cadmium telluride sensors.

13. The detector apparatus of claim 1, wherein the one or more detectors require, for operation, the constant input voltage in the predetermined range between 900 V and 1200 V.

14. The detector apparatus of claim 1, wherein the detector apparatus includes only one detector and only one second DC-DC converter.

15. The detector apparatus of claim 1, wherein the detector apparatus includes multiple detectors and multiple second DC-DC converters, each corresponding to one of the multiple detectors.
